(19) United States
(12) Patent Application Publication
(10) Pub. No.: US 2009/0257927 A1
(43) Pub. Date: Oct. 15, 2009

(54) FOLDED COAXIAL RESONATORS

(75) Inventors: KARTIK RAMASWAMY, SAN JOSE, CA (US); HIROJI HANAWA, SUNNYVALE, CA (US); KENNETH S. COLLINS, SAN JOSE, CA (US); LAWRENCE WONG, FREMONT, CA (US); ANDREW NGUYEN, SAN JOSE, CA (US); STEVEN LANE, SAN JOSE, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., SANTA CLARA, CA (US)

(21) Appl. No.: 12/371,864

(22) Filed: Feb. 16, 2009

Related U.S. Application Data
(60) Provisional application No. 61/032,793, filed on Feb. 29, 2008.

(51) Int. Cl. H01P 1/20; H01P 7/04; H05H 1/24

(52) U.S. Cl. 422/186.29; 333/222; 333/206

(57) ABSTRACT

A method for constructing a distributed element coaxial resonator includes folding a coaxial resonator to provide a structure having a decreased physical length compared to its electrical length. In various embodiments, the resonator is tuned to affect a standing wave when excited by a signal of a specific wavelength. The coaxial resonator includes inner, middle and outer conductor sections, wherein the characteristic impedance is maintained throughout the resonator.

### CROSS-REFERENCE TO RELATED APPLICATION

This application claims benefit of U.S. provisional application Ser. No. 61/032,793 filed Feb. 29, 2008 (Attorney Docket No. APPM/012984L), which is herein incorporated by reference.

### FIELD

Various embodiments of the invention generally relate to distributed electrical element resonators requiring decreased amounts of physical space with respect to wavelength (λ) to implement compared to existing methods. More specifically, various embodiments of the invention include Very High Frequency (VHF) filter implementations based on folded coaxial resonators.

### DESCRIPTION OF THE RELATED ART

Electronic filters play a fundamental role in the operation of almost all types of electronic systems, particularly communications, signal processing and control systems. Filters provide a frequency response that allows transmission of a signal within a designated passband and attenuation/rejection within a stopband. In many applications, filters are utilized to alter the phase characteristics of a signal as well.

Common types of filters include low-pass, high-pass, bandpass and bandstop (or bandreject) varieties. Filters are constructed of Inductive (L) and Capacitive (C) elements. Depending upon the filter's application and intended response, the L and C (LC) elements may either be lumped or distributed. A lumped element provides a response that is effectively concentrated at a single point, such as commercially available discrete inductors and capacitors. By contrast, a distributed element provides a response that is spread out over an electrically significant length or area, such as with respect to λ.

Lumped elements are sufficient for many applications, but have drawbacks that make them undesirable or unsuitable in many cases. Component precision is frequently a concern with lumped elements especially at higher frequencies, and lumped elements are generally limited in their capacity to handle high power levels.

Distributed elements provide improvements in the above mentioned areas, but have their own drawbacks as well. Transmission line elements such as coaxial cable stubs are commonly implemented as distributed elements in many systems. But as with all distributed elements, as operational frequency decreases (and increases), the size of the distributed element must increase correspondingly. For a transmission line distributed element such as a resonator configured for use at low frequencies, conventional methods may a line that is impractically long.

Plasma processing, for example, requires a high amount of electrical power that must undergo filtering and other electrical processing utilizing components that must be able to withstand the load. While distributed elements might appear to be a viable approach for the high power and providing component precision, plasma processing is often performed utilizing electrical excitation frequencies in the VHF range such as 162 MHz, which has a λ of 1.85 m. Thus, to construct a filter out of distributed element coaxial resonators utilizing existing methods, a stub of approximately 1.85 m is required for a full wave resonator, 0.92 m for a half wave (λ/2) resonator, and 0.46 m for a quarter wave (λ/4) resonator. Physical space constraints commonly make conventional distributed element implementations requiring dimensions such as the above impractical or impossible to implement in most cases, while the problem is only amplified even further as operational frequencies decrease. Accordingly, distributed elements are often not able to be utilized in many systems.

Therefore, a need exists for improved distributed element components.

### SUMMARY

In another embodiment a distributed element resonator includes a folded coaxial transmission line having a decreased physical length compared to its electrical wavelength. In various embodiments, the resonator is tuned to affect a standing wave when excited by a signal of a specific wavelength. The coaxial resonator includes inner, middle and outer conductor sections, wherein the characteristic impedance is maintained throughout the resonator.

Some embodiments provide a processing chamber system. The processing chamber system generally includes a processing chamber having a substrate support disposed therein, one or more coils disposed proximate the processing chamber, one or more distributed element resonators with a folded coaxial structure having a decreased physical length compared to its electrical length, and one or more RF power sources coupled to the one or more coils through the one or more distributed element resonators, the one or more RF power sources arranged to generate a plasma within the processing chamber.

### BRIEF DESCRIPTION OF THE DRAWINGS

The teachings of the present invention can be readily understood by considering the following detailed description in conjunction with the accompanying drawings, in which:

FIG. 1A depicts a coaxial resonator as known in the prior art;

FIGS. 1B-D depict folded coaxial resonators in accordance with various embodiments;

FIG. 2A depicts a bandpass filter architecture utilizing lumped elements;

FIG. 2B depicts an equivalent bandpass filter to that of FIG. 2A, utilizing folded coaxial resonators in accordance with various embodiments;

FIG. 3A depicts a bandpass filter architecture utilizing lumped elements;

FIG. 3B depicts an equivalent bandstop filter to that of FIG. 3A, utilizing folded coaxial resonators in accordance with various embodiments; and

FIG. 4 depicts an exemplary processing chamber having a filter utilizing folded coaxial resonators.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention generally provide filters based on folded coaxial resonators. The inventive filters may be used to advantage in semiconductor processing systems, among other applications where compact distributed element filters are desired.

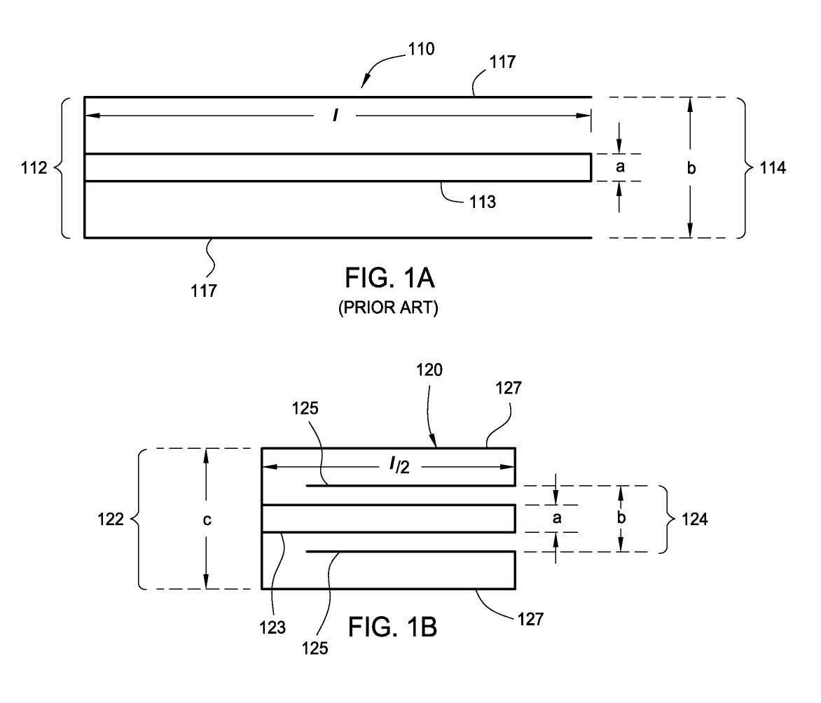

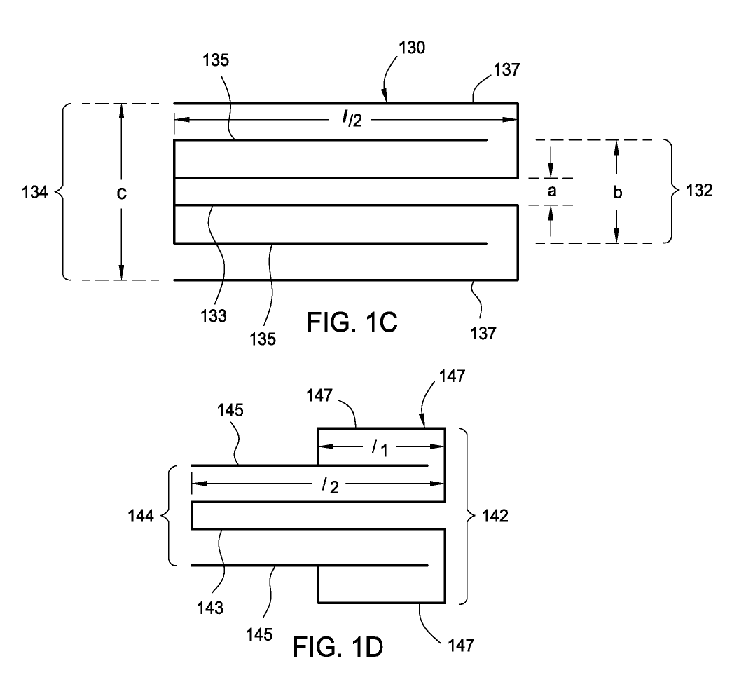

FIG. 1A depicts a conventional coaxial resonator 110, implemented utilizing methods known in the prior art. It should be noted that FIG. 1A, along with the other Figures herein, are not drawn to scale. To function, conventional coaxial resonator 110 requires a full λ/4 (electrical and physical) length, which as an example for the VHF frequency of 162 MHz, would be 0.46 m. Conventional coaxial resonator 110 has an inner conductor 113 of diameter ‘a’ and an outer conductor 117 of diameter ‘b.’ Conventional coaxial resonator 110 is terminated at opposing ends by short circuit end 112 and open circuit end 114, which respectively serve as current and voltage node boundaries. The current and voltage node boundaries provide impedance discontinuities by which (when the stub is tuned to a specific excitation wavelength) voltage and current standing waves are established in the stub.

Conventional coaxial resonator 110 is fed (provided power) at open circuit end 114 and has an input admittance:

Yᵢₙ=Y₀*Coth(α*l+j*β*l) (1)

wherein Coth is the hyperbolic cotangent operator, Y₀ is the characteristic impedance of the resonator (e.g., coaxial transmission line), α is the attenuation per unit length of structure, β is the phase constant (2π/λ) per unit length of the structure and l is the length of the structure.

FIG. 1B depicts an example of a folded coaxial resonator 120 according to one embodiment. For illustrative purposes, folded coaxial resonator 120 functions as having a full λ/4 electrical length, but is folded to a physical length of λ/8. With respect to the 162 MHz example above, folded coaxial resonator 120 would be 0.23 m, or half the physical length (I/2) of conventional coaxial resonator 110. It will be apparent to those skilled in the art and informed by the teachings herein that folded coaxial resonator 120's decreased size is beneficially suited for applications where a distributed element resonator is desired, but the implementation of a full λ/4 physically sized resonator such as conventional coaxial resonator 110 would not be practical.

Folded coaxial resonator 120 includes an inner conductor section 123 of diameter of ‘a,’ a middle conductor section 125 of diameter ‘b’ and an outer conductor section 127 of diameter ‘c.’ In various embodiments, a, b and c are related by the equation:

b=\sqrt{a*c} (2a)

The dimensional constraints of equation 2 ensure the same characteristic impedance is maintained throughout the folded coaxial resonator 120. The thickness of the middle conductor section 125 material is assumed to be negligible compared to dimensions ‘a,’ ‘b,’ and ‘c.’ and is commensurately neglected in equation (2a). Should middle conductor section 125 material thickness increase such that it is no longer negligible compared to dimensions ‘a,’ ‘b’ and ‘c,’ the constraint to maintain characteristic impedance becomes:

$$ln ( b / a ) = ln ( \frac{c}{2 * {T}_{m}} ) \qquad ( 2 b )$$

wherein Tₘ is the thickness of the inner conductor expressed in the same units as ‘a,’ ‘b,’ and ‘c.’

The folded coaxial resonator 120 includes voltage and current node boundaries, provided as an example by short circuit 122 and open circuit 124. Short circuit end 112 is provided by a short circuit between inner conductor section 123 and outer conductor section 127. Folded coaxial resonator 120 is fed at open circuit 124 and has an input admittance that can be expressed as:

Yᵢₙ=Y₀*Coth(α*2l+j*β*2l) (3)

wherein all variables are identical to those discussed with respect to equation (1).

FIG. 1C depicts another example of a folded coaxial resonator 130 according to one embodiment that is similar to folded coaxial resonator 120. Folded coaxial resonator 130 has the same physical and electrical lengths (λ/4 and λ/8) as folded coaxial resonator 120 and an input admittance characterized by equation (3). By contrast, however, folded coaxial resonator 130 has an inner conductor section 133 and middle conductor section 135 that are shorted at the structure's feed point. But the feed still appears as an open circuit 134 with respect to the resonator middle conductor section 135 and an outer conductor section 137. As with folded coaxial resonator 120, a short circuit 132 is disposed at the opposing end (with respect to feed) of the folded coaxial resonator 130. All diameter dimensions ‘a,’ ‘b’ and ‘c’ and their being related by equations (2a) and (2b) are identical to folded coaxial resonator 120.

FIG. 1D depicts yet another example of a folded coaxial resonator 140 according to one embodiment. Folded coaxial resonator 140 illustrates particular tradeoffs that may be made between the electrical and physical lengths of a folded coaxial resonator structure according to one embodiment. Specifically, folded coaxial resonator 140 includes an outer conductor section 147 of physical length l₁, and an inner conductor section 143 and middle conductor section 145 both of a physical length l₂. Physical lengths l₁ and l₂ are related by the equation:

$${l}_{1} + {l}_{2} = \frac{λ}{4} \qquad ( 4 a )$$

for a λ/4 resonator, or more generally as:

l₁+l₂=l (4b)

with respect to conventional coaxial resonator 110. All diameter dimensions ‘a,’ ‘b’ and ‘c’ and their being related by equation (3) are identical to folded coaxial resonators 120 and 130.

Folded coaxial resonator 130 includes identical dimensions ‘a,’ ‘b’ and ‘c’ to folded coaxial resonator 120 with respect to diameter. Folded coaxial resonator 130 has an input admittance that may be expressed as:

Yᵢₙ=Y₀*Coth[α(l₁+l₂)+j*β(l₁+l₂)] (5)

wherein the dimensions l₁ and l₂ correspond to l₁ and l₂ as indicated on FIG. 1D. All other variables are identical to those defined with respect to equations (1) and (3).

It is contemplated that pluralities of embodiments are achievable by appropriately configuring lengths of l₁ and l₂ to suit any specific application. It will be similarly apparent that the value l in equations (4a) and (4b) may equal other and further values including any multiple λ/4 depending upon the electrical length of the structure desired, where input impedance becomes more capacitive as electrical length decreases, and inductive as electrical length increases.

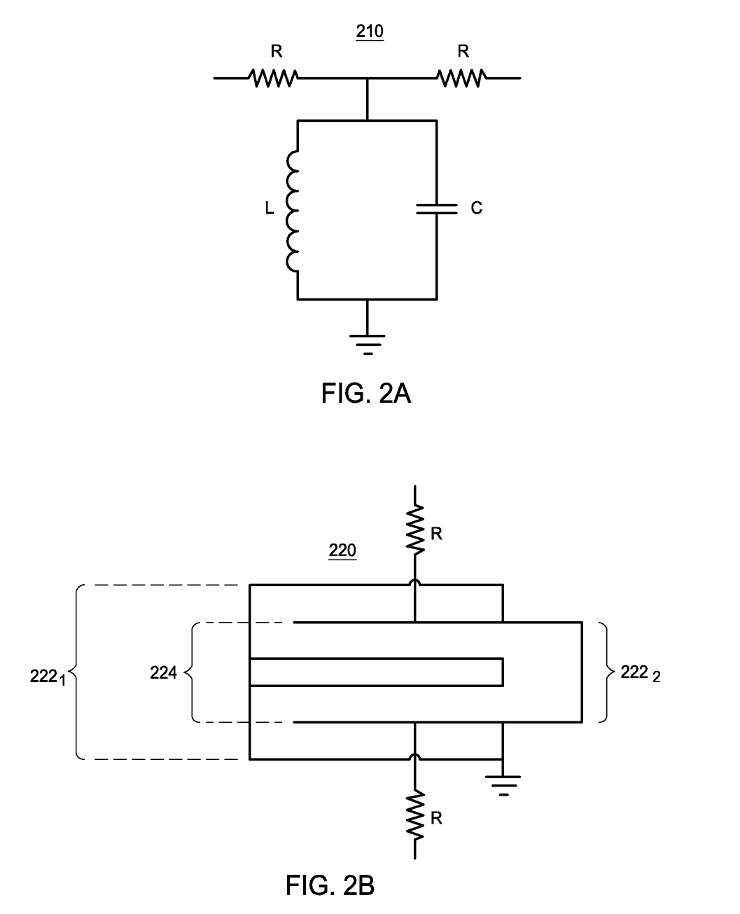

FIG. 2A depicts a bandpass filter architecture 210 utilizing discrete (lumped element) LC components. Resistance R is also shown to represent the impedance of the RF source and load before and after the filter respectively. FIG. 2B depicts an equivalent bandpass filter 220 realized utilizing equivalent folded coaxial distributed components according to one embodiment. The distributed element architecture of bandpass filter 220 is constructed utilizing a combination of folded coaxial resonators 120 of FIG. 1B and 130 of FIG. 1C with the physical dimensions thereof adjusted to obtain the applicable electrical length for a wavelength at which resonance is desired. An equivalent inductance L to the discrete inductor in FIG. 2A is provided by the combination of short circuit end 222₁ and short circuit end 222₂. An equivalent capacitance C to the discrete capacitor in FIG. 2A is provided by an open circuit end 224. Identical resistors to those as in FIG. 2A are also provided to represent the source and load resistance as mentioned.

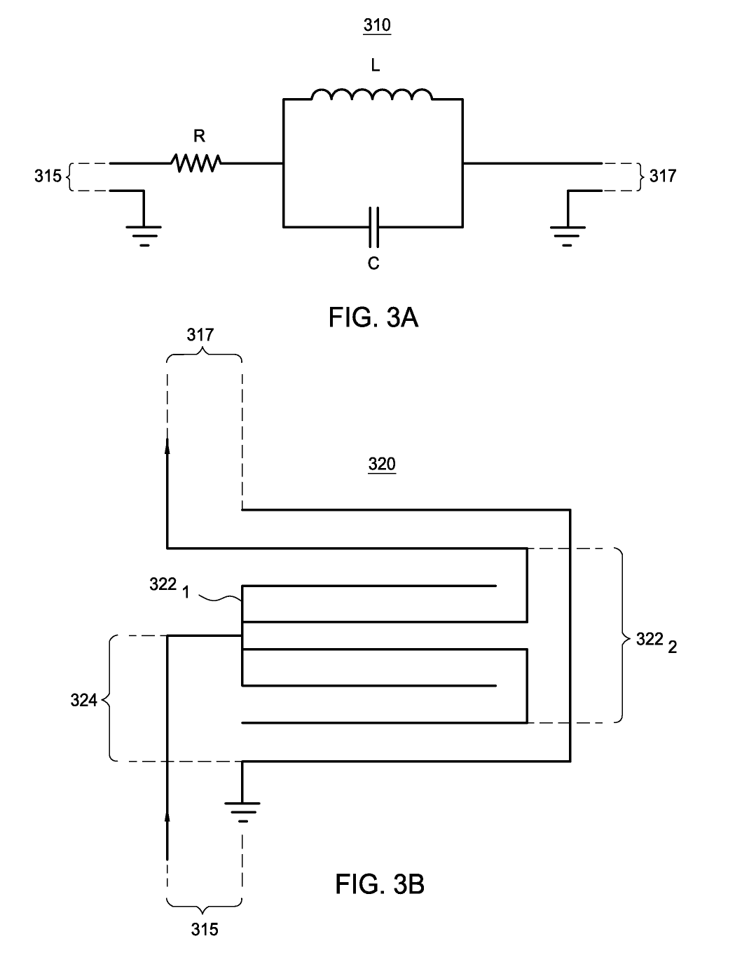

FIG. 3A depicts a bandstop filter architecture 310 utilizing discrete (lumped element) components R, L and C. Bandstop filter architecture 310 includes a feed end 315 and an output end 317. FIG. 3B depicts an equivalent bandstop filter 320 realized utilizing equivalent folded coaxial distributed components according to one embodiment. As with FIG. 2B, the distributed element architecture of bandstop filter 320 is constructed utilizing a combination of folded coaxial resonators 120 of FIG. 1B and 130 of FIG. 1C with the physical dimensions suitably adjusted to achieve resonance at a desired wavelength. Feed end 315 and output end 317 in FIG. 3B are electrically equivalent to the co-labeled elements in FIG. 3A. An equivalent inductance L to the discrete inductor in FIG. 3A is provided by short circuit sections 322₁ and 322₂, and an equivalent capacitance C to the discrete capacitor in FIG. 3A by an open circuit end 324. The discrete resistance value R in FIG. 3A is the characteristic impedance of the signal source exciting bandstop filter architecture 310 and bandstop filter 320 and is not shown in FIG. 3B.

While the bandpass filter 220 of FIG. 2B and bandstop filter of FIG. 3B have been implemented utilizing a combination of folded coaxial resonators 120 of FIG. 1B and 130 of FIG. 1C, it is contemplated that other and further folded coaxial resonant structures, including but not limited to the folded coaxial resonant structure embodiment depicted in FIG. 1D, may be fabricated using the teachings herein.

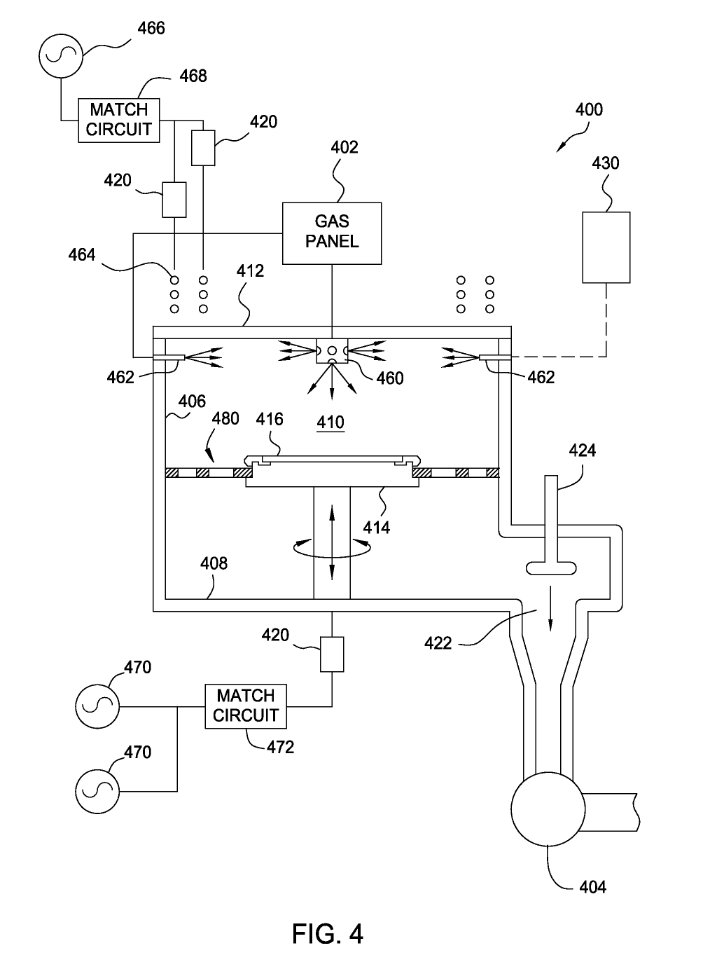

FIG. 4 depicts an exemplary plasma processing chamber 400 having one or more filters 420 constructed utilizing folded coaxial resonators as described herein. The plasma processing chamber 400 has a chamber body comprising sidewalls 406 and a bottom 408 that partially define a process volume 410 upwardly closed by a lid 412. The plasma processing chamber 400 is coupled to a gas panel 402, a vacuum pump 404 and a controller 430. A substrate support assembly 414 is provided approximately at a central region of the process volume 410 to support a substrate 416 during processing.

One or more gas distributors are disposed in the chamber above the substrate support assembly 414 to provide process and other gases into the process volume 410. The gas distributor may be one or more nozzles or ports formed in the chamber lid and/or sidewalls 406. In the embodiment depicted in FIG. 4, the gas distributor includes a gas distribution nozzle 460 provided on an inner side of the lid 412 and a plurality of peripheral nozzles 462 formed in the sidewalls 406 to flow and distribute a processing gas supplied from the gas panel 402. Gases entering the process volume 410 from the gas distribution nozzle 460 and peripheral nozzle 462 may be independently controlled. In one embodiment, the radial and downward flow from the gas distribution nozzle 460 can also be independently controlled. The processing gas is flowed from the gas distribution nozzle 460 and peripheral nozzle 462 toward the substrate support assembly 414, and is evacuated via the vacuum pump 404 through an exhaust port 422 located offset to the side of the substrate support assembly 414.

A throttle valve 424 disposed in the vicinity of the exhaust port 422 is used in conjunction with the vacuum pump 304 to control the pressure in the process volume 410. A flow equalized plate 480 which also functions as a plasma screen is provided to correct flow asymmetries across the surface of the substrate 416 due to the offset exhaust port 422.

One or more antennas or coils 464 are provided proximate the lid 412 of the plasma processing chamber 400. In the embodiment depicted in FIG. 4, two coils 464 are coupled to at least one RF power source 466 through the filter 420 and a match circuit 468. Power, applied to coil 464, is inductively coupled to the process and other gases provided in the plasma processing chamber 400 to form and/or sustain a plasma therein. In one embodiment, power is provided through the filter 420 to the coil 464 at 13.56 MHz.

One or more RF power sources 470 may be coupled to the substrate support assembly 414 to bias the substrate 416 during processing and/or the substrate support assembly 414 during chamber cleaning. In the embodiment depicted in FIG. 4, two RF power sources 470 are coupled to the substrate support assembly 414 through the filter 420 and a match circuit 472. The RF power sources 470 and filter 420 may be configured to provide power to the substrate support assembly 414 at different frequencies, for example, respectively at 60 MHz and 43.56 MHz.

Although 162 MHz has been given as an example herein of a common electrical excitation frequency at which plasma processing is performed, and for which an electrical filter may be constructed utilizing various embodiments presented herein, many other frequencies are utilized for which the foregoing embodiments may also be utilized to construct filters for. The various embodiments are fully scalable and it is fully contemplated may be adapted to any electrical frequency. As an example, 60 MHz, which is another frequency commonly utilized in plasma processing, has a λ of 5 m. For a 60 MHz λ/4 (1.25 m) electrical length resonator constructed in a manner as depicted in FIGS. 1B and 1C, a physical length of about 0.625 m would be utilized. For a 60 MHz resonator constructed in the manner as depicted in FIG. 1D, l₁+l₂ would equal 1.25 m.

Accordingly, the folded coaxial resonators described herein represent just but a few examples of the many possible embodiments that can be implemented utilizing the general principles presented herein as a whole. It is fully envisioned in fact that any form of folded coaxial structure utilizing an altered geometric arrangement to reduce overall physical length while maintaining an electrical length may be implemented. The physical construction of the folded coaxial structures may be derived from actual coaxial cable material, or any other suitable materials performing the same electrical function, including rigid structures.

While the foregoing is directed to various embodiments, other and further embodiments of the invention may be devised without departing from the basic scope thereof, and the scope thereof is determined by the claims that follow.

What is claimed is:

1. A distributed element resonator, comprising:
a folded coaxial structure having a decreased physical length compared to its electrical length.

2. The distributed element resonator of claim 1, wherein the folded coaxial structure is tuned to affect a standing wave when excited by a signal of a specific wavelength

3. The distributed element resonator of claim 1, wherein the folded coaxial structure comprises an inner conductor section, a middle conductor section and an outer conductor section.

4. The distributed element resonator of claim 3, wherein a same characteristic impedance is maintained throughout the folded coaxial structure.

5. The distributed element resonator of claim 4, wherein the inner conductor section has a diameter ‘a,’ the middle conductor section has a diameter ‘b’ and the outer conductor section has a diameter ‘c,’ and ‘a,’ ‘b’ and ‘c’ are related by
b=\sqrt{a*c}

6. The distributed element resonator of claim 4, wherein the inner conductor section has a diameter ‘a,’ the middle conductor section has a diameter ‘b’ and conductor material thickness Tₘ, and the outer conductor section has a diameter ‘c,’ and ‘a,’ ‘b’ and ‘c’ are related by
$$ln ( b / a ) = ln ( \frac{c}{2 * {T}_{m}} )$$

7. The distributed element resonator of claim 1, wherein the resonator comprises an outer conductor of physical length l₁ and middle conductor of physical length l₂, wherein
$${l}_{1} + {l}_{2} = \frac{λ}{4}$$
and λ is a wavelength of a signal exciting the resonator.

8. The distributed element resonator of claim 7, wherein l₁+l₂ equals a multiple of λ/4.

9. The distributed element resonator of claim 1, wherein folded coaxial resonators are combined to provide thereby an electrical filter.

10. The distributed element resonator of claim 1, wherein the resonator is disposed in a plasma processing chamber.

11. The distributed element resonator of claim 1, wherein the resonator is constructed of coaxial cable material.

12. The distributed element resonator of claim 1, wherein the resonator is constructed as a rigid structure.

13. The distributed element resonator of claim 3, wherein the inner conductor section and the outer conductor section are shorted.

14. The distributed element resonator of claim 3, wherein the inner conductor section and the middle conductor section are shorted.

15. The distributed element resonator of claim 3, wherein the middle conductor section and the outer conductor section are shorted.

16. A processing chamber system, comprising:
a processing chamber having a substrate support disposed therein;
one or more coils disposed proximate the processing chamber;
one or more distributed element resonators with a folded coaxial structure having a decreased physical length compared to its electrical length; and
one or more RF power sources coupled to the one or more coils through the one or more distributed element resonators, the one or more RF power sources arranged to generate a plasma within the processing chamber.
